(19) United States
(12) Patent Application Publication
(10) Pub. No.: US 2026/0143331 A1
(43) Pub. Date: May 21, 2026

(54) METHOD, DEVICE, AND MEDIUM FOR CARD PROFILE MANAGEMENT SERVICE

(71) Applicant: Verizon Patent and Licensing Inc., Basking Ridge, NJ (US)

(72) Inventors: Zhengfang Chen, Millburn, NJ (US); Warren Hojilla Uy, Randolph, NJ (US); Kyung Min Seo, Oakland, MI (US); Kala Narayanan, Piscataway, NJ (US)

(21) Appl. No.: 18/953,796

(22) Filed: Nov. 20, 2024

(51) Int. Cl. H04W 8/20; H04W 12/69

(52) U.S. Cl. CPC H04W 8/205; H04W 12/69

(57) ABSTRACT

A method, a network device, and a non-transitory computer-readable storage medium are described in relation to a card profile management service. The card profile management service may be implemented by a card, an end device, or a combination of both. The card profile management service may include preventing the enablement of a profile on an end device based on service type data, such as metadata of the profile, which may indicate a type of the profile. The card profile management service may include restricting the use of the profile to certain end device applications of the end device.

### BACKGROUND

End devices may access and use various networks, applications, and services based on certain configurations at the end devices. For example, the end device may include a Universal Integrated Circuit Card (UICC), an embedded UICC (eUICC), or the like, that includes a profile, an application, an operating system (OS), among other elements.

### BRIEF DESCRIPTION OF THE DRAWINGS

FIG. 1 is a diagram illustrating an exemplary environment in which an exemplary embodiment of a card profile management service may be implemented;

FIG. 2A is a diagram illustrating another exemplary environment in which an exemplary process of an exemplary embodiment of the card profile management service may be implemented according to an exemplary scenario;

FIG. 2B is a diagram illustrating another exemplary process of an exemplary embodiment of the card profile management service may be implemented according to an exemplary scenario;

FIG. 2C is a diagram illustrating yet another exemplary process of an exemplary embodiment of the card profile management service may be implemented according to an exemplary scenario;

FIG. 2D is a diagram illustrating still another exemplary process of an exemplary embodiment of the card profile management service may be implemented according to an exemplary scenario;

FIG. 2E is a diagram illustrating still yet another exemplary process of an exemplary embodiment of the card profile management service may be implemented according to an exemplary scenario;

FIG. 2F is a diagram illustrating exemplary data of an exemplary embodiment of the card profile management service;

FIG. 3 is a diagram illustrating exemplary components of a device that may correspond to one or more of the devices illustrated and described herein;

FIG. 4 is a flow diagram illustrating an exemplary process of an exemplary embodiment of the card profile management service;

FIG. 5 is a flow diagram illustrating another exemplary process of an exemplary embodiment of the card profile management service;

FIG. 6 is a flow diagram illustrating yet another exemplary process of an exemplary embodiment of the card profile management service;

FIG. 7 is a flow diagram illustrating still another exemplary process of an exemplary embodiment of the card profile management service; and

FIG. 8 is a flow diagram illustrating still yet another exemplary process of an exemplary embodiment of the card profile management service.

### DETAILED DESCRIPTION

The following detailed description refers to the accompanying drawings. The same reference numbers in different drawings may identify the same or similar elements. Also, the following detailed description does not limit the invention.

A service provider, a network provider, a network operator, a wireless carrier, or another type of entity may have to manage various aspects of end devices that support wireless access to various networks, applications, and/or other services. For example, an end device may include one or multiple UICCs, eUICCs, a similar type of secure element (SE) or integrated trusted execution environment (TEE) that may provide for or support remote subscriber identity module (SIM) provisioning and use of profiles, or the like (also referred to generally as a “card” for description purposes). The card may include hardware and may include various types of data, an application, software, an OS, and/or other types of executables that may be stored on and executed by the card, for example. The card may host a profile, which may include subscription data, security authentication and ciphering information, network configuration information (e.g., roaming files/configuration, etc.), applications (e.g., USIM, etc.), algorithms (e.g., encryption, decryption, etc.), and so forth.

Currently, a network standards entity, such as the GSM Association (GSMA) defines technical specifications for architectures of an eUICC, such as a consumer architecture and a non-consumer (e.g., machine-to-machine (M2M), Internet of Things (IoT)) architectures. The implementations on the eUICC (e.g., OS, applications, etc.) are typically owned by eUICC vendors and the eUICC profiles are typically owned by a wireless operator or the like.

The eUICC may be manufactured as a consumer card or a non-consumer card. However, network operators, wireless operators, or the like may define the eUICC profile as a consumer type or a non-consumer type with respective service price plans. Typically, consumer service plans have a higher price plan range compared to non-consumer service plans.

There are industry proposals to converge different eUICC architectures into a single eUICC product. However, such a proposal introduces a technical problem in the association between an eUICC profile and appropriate service during end device operation. For example, if the end device is not properly selecting the correct service based on the eUICC profile, a user may take advantage of a cheaper non-consumer service plan (e.g., IoT plan) for data applications associated with a consumer service.

According to exemplary embodiments, a card profile management service is described. According to various exemplary embodiments, depending on the implementations, the card profile management service may be implemented on an end device, the card, or a combination of the card and the end device, as described herein.

According to an exemplary embodiment, the card profile management service may provide data indicating a service type of a profile, as described herein. For example, profile metadata of an eUICC profile may indicate a service type, such as consumer, telematics, low-cost-data, M2M, IoT, or another (current or prospective) standard or proprietary nomenclature of the service type. According to other examples, the service type data may be packaged with the profile in some other manner (e.g., not as metadata), data included in a profile package, or the like.

According to an exemplary embodiment, the card profile management service may prevent the enablement of a profile based on the service type data. Depending on the end device and/or type of card architecture (e.g., consumer, M2M, IoT, future generation, etc.), the logic of the card profile management service may be implemented as a local profile assistant (LPA), an IoT profile assistant (IPA), a subscription manager (SM), an SM secure routing (SM-SR), or similar functioning element or system application of the card or of the end device (also referred to generally as a “profile assistant” or “PA” for description purposes) that may prevent the enablement of the profile based on the service type of the profile, as described herein. According to various exemplary embodiments, the profile assistant may be implemented in the end device or in the card. For example, the profile assistant may be implemented as an LPA in the device (LPAd), an LPA in the eUICC (LPAe), an IPA in the IoT device (IPAd), an IPA in the eUICC (IPAe), and so forth.

According to an exemplary embodiment, the profile assistant may prevent the enablement of the profile via a user interface (UI) component of the profile assistant. For example, an eUICC of a smartphone may store an M2M profile and a consumer profile. According to an exemplary embodiment, the LPA may prevent the enablement of the M2M profile by omitting the M2M profile to be displayed or presented via the LPA user interface (LUI), which in turn may prevent a user from enabling the M2M profile on the smartphone. According to other exemplary embodiments, the profile assistant may be configured to prevent the enablement of the profile based on the service type data of the profile, a component of the profile assistant other than the UI component, signaling with other components of the card or end device during an enablement procedure, and so forth.

According to an exemplary embodiment, the card profile management service may prevent the use of a profile. According to an exemplary embodiment, the profile assistant may prevent the use of a profile based on the service type data. For example, depending on the end device, a user may not be able to use a particular profile among multiple types of profiles. According to another exemplary embodiment, the profile assistant may restrict or limit the use of the profile based on the service type data. For example, the profile assistant may restrict or limit the use of the profile to a certain data service and/or an end device application. By way of further example, the profile assistant may limit the use of an M2M profile to a data service or a particular end device application that connects to a specified Internet Protocol (IP) address of a network device. The data service may have lower limits regarding the amount of data and/or another characteristics associated with a data session (e.g., intermittent traffic, low bandwidth, low throughput, minimal quality of service (QoS) requirements, etc.) relative to other data services and/or end device applications (e.g., video streaming, augmented reality, etc.) associated with a consumer profile, for example.

According to yet another exemplary embodiment, the card profile management service may provide data that includes a (first) signature for the profile. According to an embodiment, the signature may be included in the profile metadata, data that is packaged with the profile, data of the profile package, or the like, as described herein. According to various exemplary embodiments, the signature may be implemented as a digital signature, a hash-based signature, a string that provides a particular security measure (e.g., authentication, integrity, non-repudiation, authorization, etc.), or the like.

According to an exemplary embodiment, the card profile management service may provide data that includes a (second) signature for the profile assistant. According to an exemplary embodiment, the profile assistant may compare the (first) signature of the profile to the (second) signature. Based on the result of the comparison, the profile assistant may allow or prevent the enablement of the profile. For example, the profile assistant may allow or enable the profile when the signatures match.

According to still other exemplary embodiments, the card profile management service may include a policy that governs the operation and/or management of profiles by a user of an end device and associated card. According to various exemplary embodiments, the policy may be implemented by the profile assistant, a modem of the end device, or by an application, such as a card application, an original equipment manufacturer (OEM) application, or some combination thereof. According to an exemplary embodiment, the policy may restrict a user from operating or managing a profile. For example, the policy may prevent the profile (e.g., an M2M profile or another type of profile) from being displayed via a LUI.

According to yet other exemplary embodiments, the card profile management service may include type and service data that governs the use of a profile. For example, the type and service data may include data that correlates the service type of the profile to one or multiple data services and/or end device applications.

In view of the foregoing, the card profile management service may address various issues associated with a converged eUICC architecture amongst existing consumer and non-consumer eUICC architectures. For example, the card profile management service may support authorized use of profiles and access to corresponding services while mitigating unauthorized network access via misuse of profiles, illegitimate usage of network resources, and so forth.

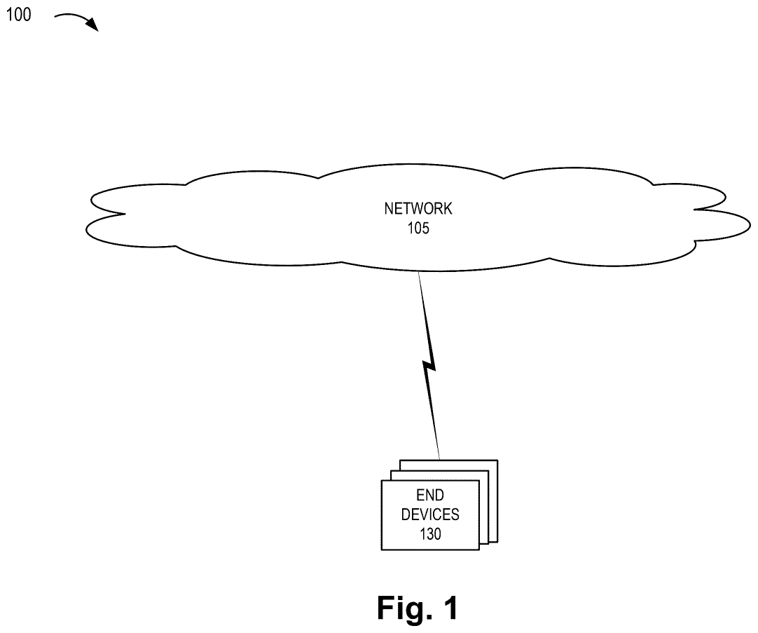

FIG. 1 is a diagram illustrating an exemplary environment 100 in which an exemplary embodiment of card profile management service may be implemented. As illustrated, environment 100 includes a network 105 and end devices 130 (also referred to individually or generally as end device 130).

Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Network 105 may include an access network of one or multiple types and technologies. For example, the access network may be implemented to include a Fifth Generation (5G) radio access network (RAN), a future generation RAN (e.g., a Sixth Generation (6G) RAN, a Seventh Generation (7G) RAN, or a subsequent generation RAN), a centralized-RAN (C-RAN), an O-RAN, and/or another type of access network, such as a legacy RAN (e.g., a Fourth Generation (4G) RAN, etc.). Depending on the implementation, the access network may include one or multiple types of network devices, such as a network generation Node B (gNB), an evolved Node B (eNB), a remote radio head (RRH), a baseband unit (BBU), a radio unit (RU), a remote radio unit (RRU), a centralized unit (CU), a distributed unit (DU), a small cell node (e.g., a picocell device, a femtocell device, a microcell device, a home eNB, etc.), a future generation wireless access device (e.g., a 6G wireless station, a 7G wireless station, or another generation of wireless station), and/or so forth.

Network 105 may also include a core network. The core network may include a complementary network of the access network. For example, the core network may be implemented to include a 5G core network, an evolved packet core (EPC) of an LTE network, an LTE-Advanced (LTE-A) network, and/or an LTE-A Pro network, a future generation core network (e.g., a 5G Advanced, a 6G, a 7G, or another generation of core network), and/or another type of core network. The core network may include corresponding network devices relating to the type of core network.

Network 105 may also include an application layer network that provides an end device application service. For example, the application layer network may include a cloud network, a private network, a public network, a multi-access edge computing (MEC) network, a fog network, the Internet, a packet data network (PDN), a service provider network, the World Wide Web (WWW), an Internet Protocol (IP) Multimedia Subsystem (IMS) network, a Rich Communication Service (RCS) network, a software defined (SD) network, a virtual network, a packet-switched network, a data center, or other type of network that may provide access to and may host an end device application service. The end device application service may pertain to a broadband service in dense areas (e.g., pervasive video, smart office, operator cloud services, video/photo sharing, etc.), an enhanced mobile broadband (eMBB) service, an IoT service (e.g., smart wearables, sensors, mobile video surveillance, smart cities, connected home, etc.), an extreme real-time communications service (e.g., tactile Internet, augmented reality (AR), virtual reality (VR), etc.), a lifeline communications service (e.g., natural disaster, emergency response, etc.), a communication service (e.g., email, text (e.g., Short Messaging Service (SMS), Multimedia Messaging Service (MMS), voice, video calling, video conferencing, instant messaging, etc.), a video streaming service, a fitness service, a navigation service, web browsing, an online gaming service, an M2M service, a telematics service, and/or the like.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a phablet, an IoT device, a telematics device, an M2M device, or another type of wireless device or user equipment (UE). End device 130 may be configured to execute various types of software (e.g., applications, programs, etc.). The number and the types of software may vary among end devices 130. End devices 130 may include “edge-aware” and/or “edge-unaware” application service clients. For purposes of description, end device 130 is not considered a network device.

According to an exemplary embodiment, end device 130 includes a card. According to an exemplary embodiment, the card of end device 130 may include logic of the card profile management service, as described herein. For example, the card may include data, which indicates a service type of a profile and a profile assistant that includes logic that may determine whether enablement of the profile is allowable or not based on the service type data, as described herein. According to another example, the profile assistant may prevent the enablement of the profile via the UI of the profile assistant, as described herein.

Additionally, or alternatively, the card may include a profile assistant that includes logic that may prevent or restrict use of a profile, as described herein. Additionally, or alternatively, the card may include data, which includes a signature for a profile, and a profile assistant that includes logic that may compare the signature to a signature of the profile assistant to determine whether the profile can be enabled or not. Additionally, or alternatively, the card may include logic that governs the operation and/or management of a profile by a user based on a policy or type and service data, as described herein.

Additionally, or alternatively, an embodiment of the card profile management service may be implemented by the end device or a combination of the card and the end device, as described herein.

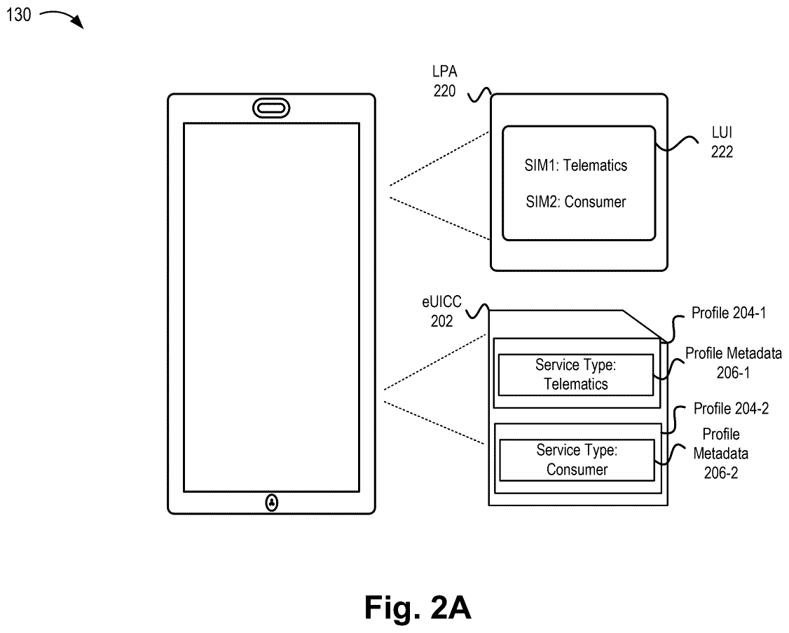

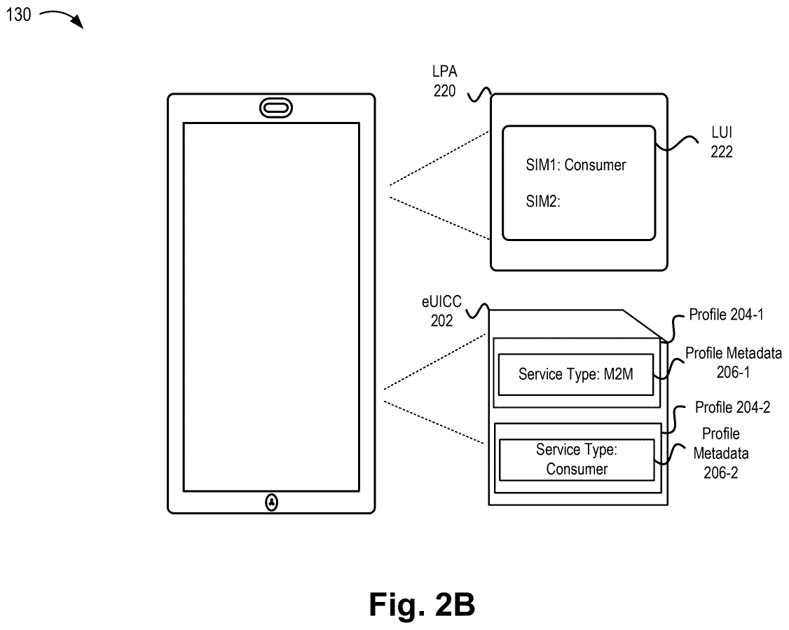

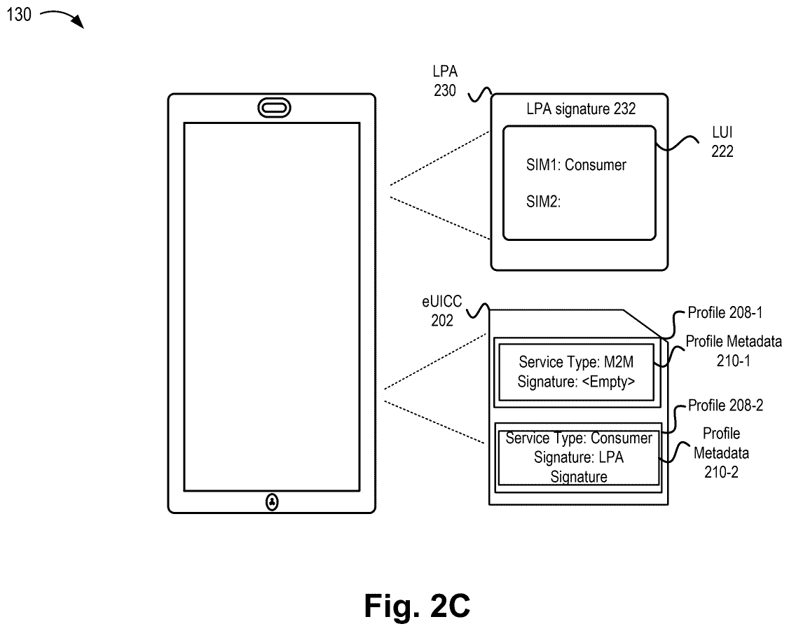

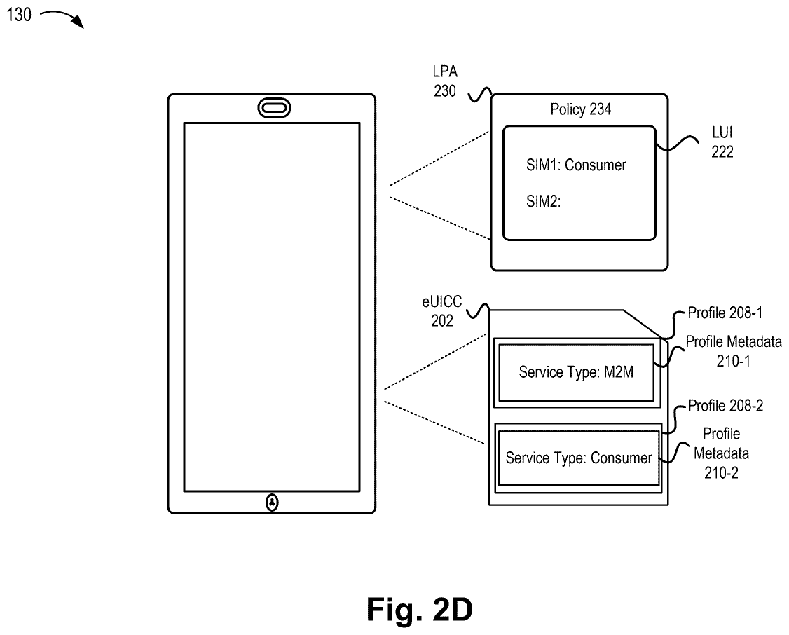

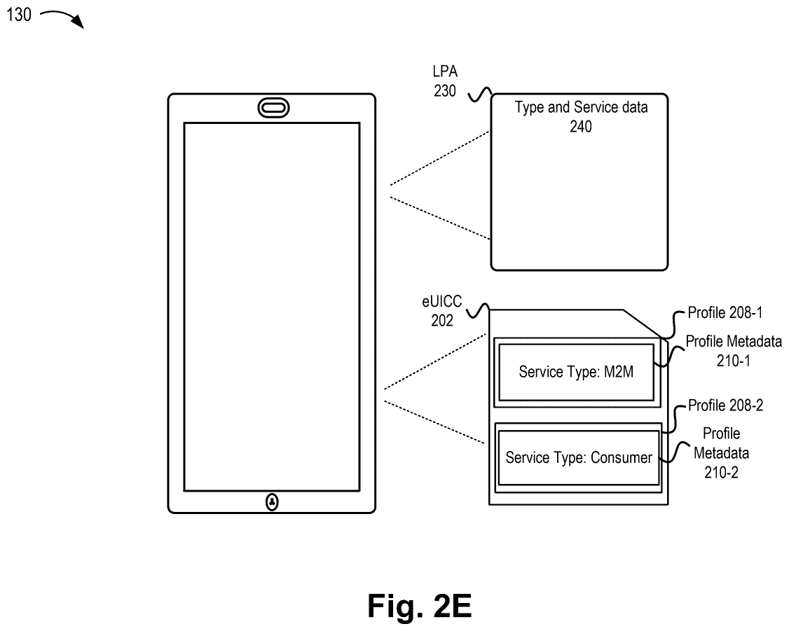

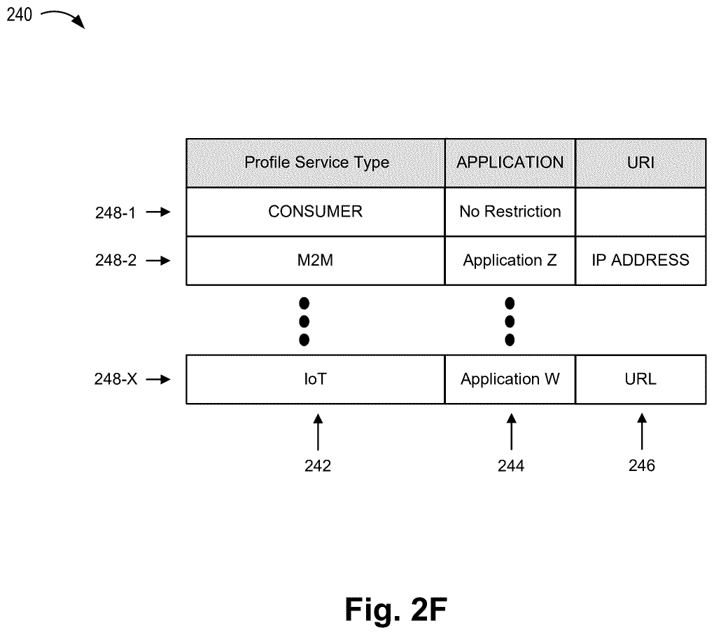

FIG. 2A is a diagram illustrating an exemplary process in which an exemplary embodiment of the card profile management service may be implemented. As illustrated, according to this example, end device 130 may include an eUICC 202. eUICC 202 includes profiles 204-1 and 204-2 (also referred to collectively as profiles 204, and generally or individually as profile 204). eUICC 202 may further include profile metadata 206-1 and 206-2. According to this example, profile metadata 206-1 may indicate a service type of “Telematics” for profile 204-1, and profile metadata 206-2 may indicate a service type of “Consumer” for profile 204-2. As further illustrated, end device 130 may include an LPA 220. LPA 220 may include an LUI 222.

According to an exemplary scenario, profile 204-1 may be enabled on end device 130. According to one example, LPA 220 may restrict or limit the use of profile 204-1, which has a service type of “Telematics,” to a particular end device application(not illustrated) hosted at end device 130 based on the service type data. According to an exemplary scenario, in response to detecting the launching of an end device application, LPA 220 may determine whether the use of the end device application with profile 204-1 enabled is permitted. According to one exemplary implementation, when use of profile 204-1 is not permitted, LPA 220 may disable profile 204-1. Otherwise, when use of profile 204-1 is permitted, LPA 220 may allow the use of profile 204-1 while or under which the end device application executes.

FIG. 2B is a diagram illustrating another exemplary process in which an exemplary embodiment of the card profile management service may be implemented. As illustrated, according to this example, end device 130 may include eUICC 202 and similar elements as previously described in relation to FIG. 2A. According to this exemplary scenario, assume that profile metadata 206-1 indicates a service type of “M2M.” Based on the service type data, LPA 220 may prevent enablement of profile 204-1. For example, as illustrated, LUI 222 may omit displaying profile 204-1 (e.g., SIM2). As a consequence, a user (not illustrated) of end device 130 may be unable to indicate or select profile 204-1, which may be a part of an enablement procedure.

FIG. 2C is a diagram illustrating still another exemplary process in which an exemplary embodiment of the card profile management service may be implemented. As illustrated, according to this example, end device 130 may include eUICC 202 and similar elements as previously described in relation to FIG. 2A. For example, eUICC 202 may include profiles 208-1 and 208-2 and profile metadata 210-1 and 210-2. According to this example, profile metadata 210-2 includes an LPA signature and profile metadata 210-1 does not include a signature (e.g., empty). According to another example, profile metadata 210-1 may include a signature other than an LPA signature (e.g., a non-LPA signature, an invalid signature, or the like). End device 130 may include an LPA 230. LPA 230 may include an LPA signature 232.

According to an exemplary process, LPA 230 may prevent the enablement of profile 208-1 based on a comparison between LPA signature 232 and the “Empty” or non-LPA signature of profile metadata 210-1. Additionally, a LUI 222 may not display SIM2 (e.g., associated with profile 208-1), which further may prevent the enablement of profile 208-1.

FIG. 2D is a diagram illustrating yet another exemplary process in which an exemplary embodiment of the card profile management service may be implemented. As illustrated, according to this example, end device 130 may include eUICC 202 and similar elements as previously described in relation to FIG. 2C. Additionally, according to this exemplary implementation, LPA 230 may include a policy 234. Policy 234 may prevent a user from operating or managing profile 208. According to this exemplary scenario, LPA 230 may prevent the user of end device 130 from managing or operating an M2M profile (e.g., profile 208-1) based on a reading of the service type data in view of policy 234. According to an exemplary embodiment, based on policy 234 and the service type data of profile 208-1 (e.g., profile metadata 210-1), LPA 230 may omit displaying profile 208-1 via LUI 222. As a consequence, the user may not be able to enable profile 208-1 as well as use profile 208-1 for any end device application.

As previously described, according to other exemplary embodiments, policy 234 may be implemented by the modem of end device 130, a card application (e.g., an application of eUICC 202), an OEM application, or some combination thereof.

FIG. 2E is a diagram illustrating still yet another exemplary process in which an exemplary embodiment of the card profile management service may be implemented. As illustrated, according to this example, end device 130 may include eUICC 202 and similar elements as previously described in relation to FIG. 2C. Additionally, according to this exemplary implementation, LPA 230 may include type and service data 240. Type and service data 240 may restrict use of a profile 208. Exemplary type and service data 240 is illustrated and described in relation to FIG. 2F.

FIG. 2F illustrates exemplary type and service data 240. As illustrated, type and service data 240 may include profile service type data correlated to other types of data. For example, a table may include a profile service type field 242, an application field 244, and a uniform resource indicator (URI) field 246. As further illustrated, the table includes entries 248-1 and 248-X (also referred to as entries 248 and generally or individually as entry 248) that each includes a grouping of fields 242 through 246 that are correlated. Type and service data 240 is illustrated in tabular form merely for the sake of description. In this regard, type and service data 240 may be implemented in a data structure different from a table (e.g., a list, a flat file, etc.). The number of entries and the number and type of fields are exemplary. Additionally, the data or values illustrated in a field of the table is merely exemplary.

Profile service type field 242 may include data that indicates a service type of a profile, as described herein. For example, profile service type field 242 may indicate a consumer type, an M2M type, an IoT type, and/or another configurable service type of a profile.

Application field 244 may include data that indicates an end device application and/or a data service. For example, the data may be implemented as a unique identifier, a name, or a similar type of string.

URI field 246 may include data that indicates a URI associated with the application or the data service of field 244. For example, the data may be implemented as an IP address, a uniform resource locator (URL), a fully qualified domain name (FQDN), an access point name (APN), or the like.

According to other exemplary embodiments, type, and service data 240 may include and correlate additional, fewer, or different instances of data in support of card profile management service, as described herein.

Referring back to FIG. 2E, assume that profile 208-1 (an M2M profile) is enabled on end device 130. A user (not illustrated) may launch an end device application for connection to network 105. LPA 230 may compare the service type of the enabled profile and an end device application identifier of the launched end device application to type and service data 240. Based on the result of the comparison, LPA 230 may determine whether use of the end device application or data service is permitted or not. According to some embodiments, when profile 208-1 and end device application pair are not permitted, LPA 230 may disable profile 208-1 or invoke some other type of procedure that prevents use of the end device application while profile 208-1 is enabled. For example, LPA 230 may cause a component of end device 130 to terminate an establishment or ongoing data session of the end device application and/or close or shut-down the end device application such that the end device application may not be used with profile 208-1. According to another exemplary implementation, end device 130 may store a device user profile, which may map profile 208-1 (e.g., via LPA 230) to one or multiple end device applications. End device 130 may restrict the use of the end device application based on the device user profile. According to yet another exemplary implementation, a user may configure (or end device 130 may be configured) such that a first SIM may be used for a first category of data service (e.g., Internet PDN or another type of service) and a second SIM may be used for a second category of data service (e.g., IMS PDN or another type of service). LPA 230 may identify and communicate the active or enabled SIM to end device connection manager logic of end device 130. The end device connection manager logic may restrict the use of end device applications based on the identified SIM. According to still other exemplary implementations, card logic and/or logic of end device 130 may restrict the use of an end device application based on a mapping or correlation between profile 208/profile metadata 210 and a (permitted) end device application identifier, a (permitted) category of end device application, a (restricted) end device application identifier, a (restricted) category of end device application, or the like.

FIGS. 2A-2E are diagrams illustrating exemplary processes of exemplary embodiments of the card profile management service. According to other exemplary embodiments and scenarios, a process may include additional operations, fewer operations, and/or different operations.

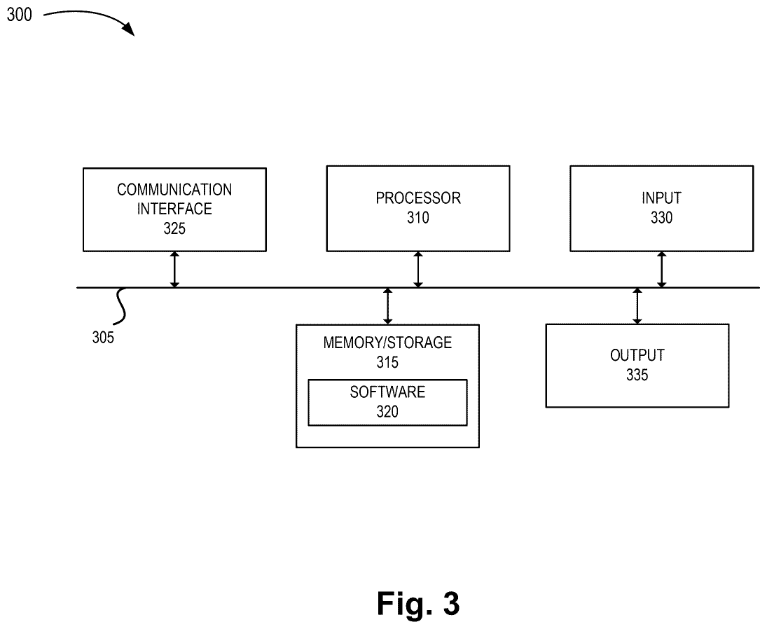

FIG. 3 is a diagram illustrating exemplary components of a device 300 that may be included in one or more of the devices described herein. For example, device 300 may correspond to end device 130, eUICC 202 and/or other types of devices and/or cards, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 may include a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 may include one or multiple processors, microprocessors, data processors, co-processors, digital signal processors (DSPs), image processing units (ISPs), graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 may include one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, a solid state drive, mass storage, off-line storage, or some other type of storing medium. Memory/storage 315 may store data, software, and/or instructions related to the operation of device 300.

Software 320 may include an application or a program that provides a function and/or a process. As an example, with reference to a card (e.g., eUICC 202 or another type of card as described herein), software 320 may include an application that, when executed by processor 310, provides a function and/or a process of card profile management service, as described herein. Additionally, with reference to end device 130, software 320 may include an application that, when executed by processor 310, provides a function and/or a process of card profile management service, as described herein. Software 320 may also include firmware, middleware, microcode, hardware description language (HDL), and/or other form of instruction. Software 320 may also be virtualized. Software 320 may further include an operating system (OS) (e.g., Windows, Linux, Android, proprietary, etc.).

Communication interface 325 may enable device 300 to communicate with other devices, networks, systems, and/or the like. Communication interface 325 may include one or multiple wireless interfaces, optical interfaces, and/or wired interfaces. For example, communication interface 325 may include one or multiple transmitters and receivers, or transceivers. Communication interface 325 may include a modem. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions that are stored by memory/storage 315 cause processor 310 to perform a function or a process described herein. Alternatively, for example, according to other implementations, device 300 performs a function or a process described herein based on the execution of hardware (processor 310, etc.).

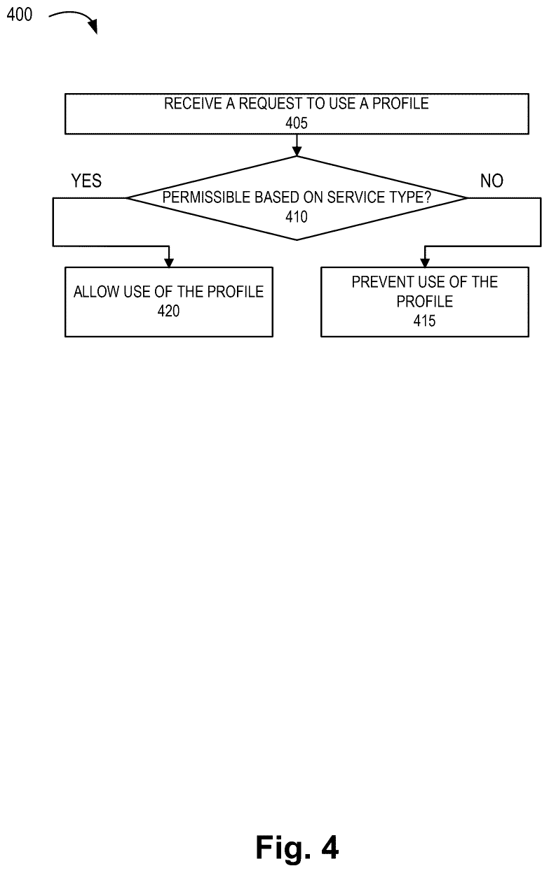

FIG. 4 is a flow diagram illustrating an exemplary process 400 of an exemplary embodiment of the card profile management service. According to an exemplary embodiment, process 400 may be implemented by a card of end device 130, end device 130, or a combination of both the card and end device 130. According to an exemplary implementation, processor 310 may execute software 320 to perform a step of process 400, as described herein. Alternatively, a step may be performed by execution of only hardware. For purposes of description, process 400 is described as being performed by a profile assistant. Additionally, according to an exemplary embodiment of process 400, profiles are associated with service type data, as described herein.

In block 405, the profile assistant may receive a request to use a profile. For example, the profile assistant may receive a request or a notification of an attempt to use an end device application or data service under the profile.

In block 410, the profile assistant may determine whether the use is permissible based on the service type of profile. For example, the profile assistant may analyze the service type of the profile. The profile assistant may further be configured with permissible or impermissible data services or applications that may be used with the profile of such service type. The profile assistant may determine whether the end device application or data service is permissible or impermissible based on such configuration.

When the profile assistant determines that the use of the profile is not permissible based on the service type (block 410—NO), the profile assistant may prevent the use of the profile (block 415). For example, the profile assistant may disable the profile or invoke some other type of procedure that prevents use of the end device application while the profile is enabled.

When the profile assistant determines that the use of the profile is permissible based on the service type (block 410—YES), the profile assistant may allow the use of the profile (block 420).

FIG. 4 illustrates an exemplary process of the card profile management service, according to other exemplary embodiments, the card profile management service may perform additional operations, fewer operations, and/or different operations than those illustrated and described.

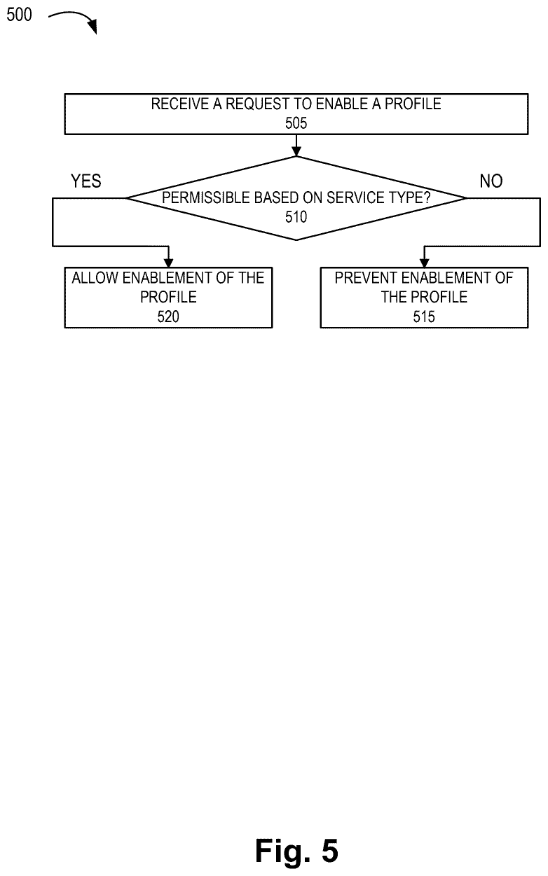

FIG. 5 is a flow diagram illustrating an exemplary process 500 of an exemplary embodiment of the card profile management service. According to an exemplary embodiment, process 500 may be implemented by a card of end device 130, end device 130, or a combination of both the card and end device 130. According to an exemplary implementation, processor 310 may execute software 320 to perform a step of process 500, as described herein. Alternatively, a step may be performed by execution of only hardware. For purposes of description, process 500 is described as being performed by a profile assistant. Additionally, according to an exemplary embodiment of process 500, profiles are associated with service type data, as described herein.

In block 505, the profile assistant may receive a request to enable a profile. For example, the request may be received via a UI component of the profile assistant. According to another example, the request may be received via a component of the profile assistant other than the UI component.

In block 510, the profile assistant may determine whether enablement of the profile is permissible based on the service type data of the profile to be enabled. For example, the profile assistant may be configured to allow or prevent one or multiple types of profiles based on the service type data.

When the profile assistant determines that the profile cannot be enabled (block 510-NO), the profile assistant may prevent the enablement of the profile (block 515). When the profile assistant determines that the profile can be enabled (block 510—YES), the profile assistant may allow the enablement of the profile (block 520).

FIG. 5 illustrates an exemplary process of the card profile management service, according to other exemplary embodiments, the card profile management service may perform additional operations, fewer operations, and/or different operations than those illustrated and described. For example, according to other exemplary embodiments, block 505 may be omitted. For example, a UI component of the profile assistant may not display the profile, which in turn may prevent receiving a request to enable the profile.

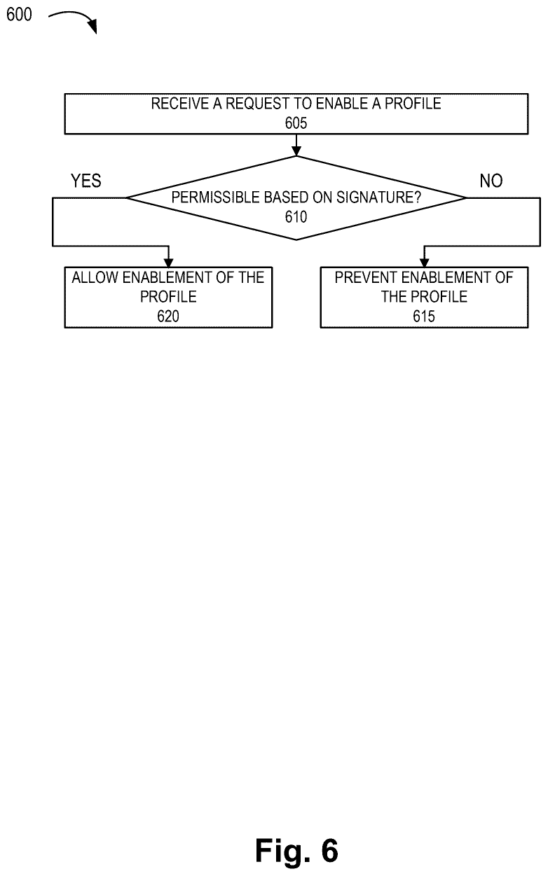

FIG. 6 is a flow diagram illustrating an exemplary process 600 of an exemplary embodiment of the card profile management service. According to an exemplary embodiment, process 600 may be implemented by a card of end device 130, end device 130, or a combination of both the card and end device 130. According to an exemplary implementation, processor 310 may execute software 320 to perform a step of process 600, as described herein. Alternatively, a step may be performed by execution of only hardware. For purposes of description, process 600 is described as being performed by a profile assistant. Additionally, according to an exemplary embodiment of process 600, profiles are associated with signatures, as described herein.

In block 605, the profile assistant may receive a request to enable a profile. For example, the request may be received via a UI component of the profile assistant. According to another example, the request may be received via a component of the profile assistant other than the UI component.

In block 610, the profile assistant may determine whether enablement of the profile is permissible based on a signature of the profile to be enabled. For example, the profile assistant may compare the signature of the profile to a signature of the profile assistant. Based on the result of the comparison, the profile assistant may determine whether enablement of the profile is permitted or not. For example, when the signatures match, the profile may be enabled, and when the signatures do not match, the profile may not be enabled.

When the profile assistant determines that the profile cannot be enabled (block 610-NO), the profile assistant may prevent the enablement of the profile (block 615). When the profile assistant determines that the profile can be enabled (block 610-YES), the profile assistant may allow the enablement of the profile (block 620).

FIG. 6 illustrates an exemplary process of the card profile management service, according to other exemplary embodiments, the card profile management service may perform additional operations, fewer operations, and/or different operations than those illustrated and described.

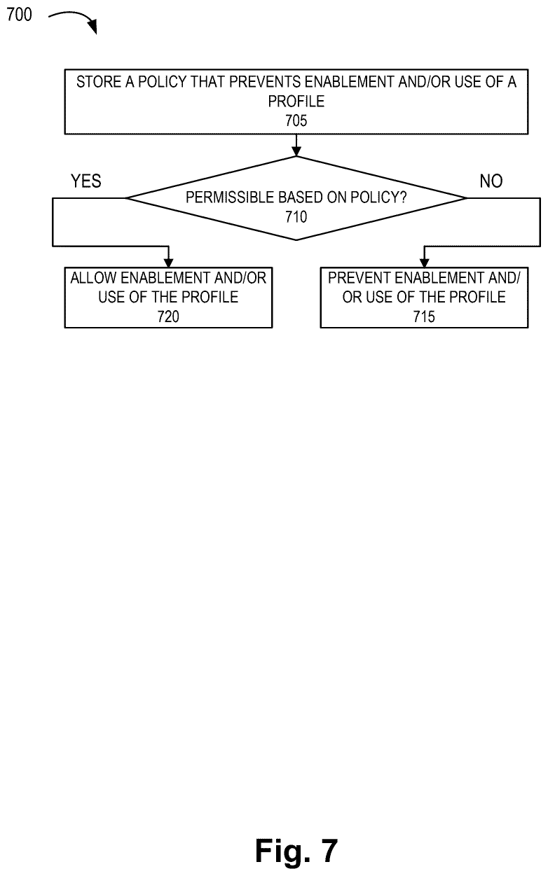

FIG. 7 is a flow diagram illustrating an exemplary process 700 of an exemplary embodiment of the card profile management service. According to an exemplary embodiment, process 700 may be implemented by a card of end device 130, end device 130, or a combination of both the card and end device 130. According to an exemplary implementation, processor 310 may execute software 320 to perform a step of process 700, as described herein. Alternatively, a step may be performed by execution of only hardware. For purposes of description, process 700 is described as being performed by a profile assistant. Additionally, according to an exemplary embodiment of process 700, profiles are associated with service type data and profile assistant may be configured with a policy, as described herein.

In block 705, the profile assistant may store (or have access to) a policy that prevents enablement or use of a profile. For example, the policy may indicate that a particular type of profile, which may be indicated by service type data as described herein, may not be enabled and/or used.

In block 710, the profile assistant may determine whether enablement or use of the profile is permissible based on the policy. For example, the profile assistant may analyze the policy and the service type of the profile to determine whether the policy permits or prevents the enablement or use of the profile.

When the profile assistant determines that the profile cannot be enabled or used (block 710—NO), the profile assistant may prevent the enablement or use of the profile (block 715). For example, according to an exemplary implementation, a UI component of the profile assistant may omit access or presentation of the profile. When the profile assistant determines that the profile can be enabled or used (block 710—YES), the profile assistant may allow the enablement or use of the profile (block 720).

FIG. 7 illustrates an exemplary process of the card profile management service, according to other exemplary embodiments, the card profile management service may perform additional operations, fewer operations, and/or different operations than those illustrated and described. As previously described, process 700 may be performed by a component different from the profile assistant, such as an OEM application, the modem of end device 130, a card application other than the profile assistant, or some sub-combination thereof.

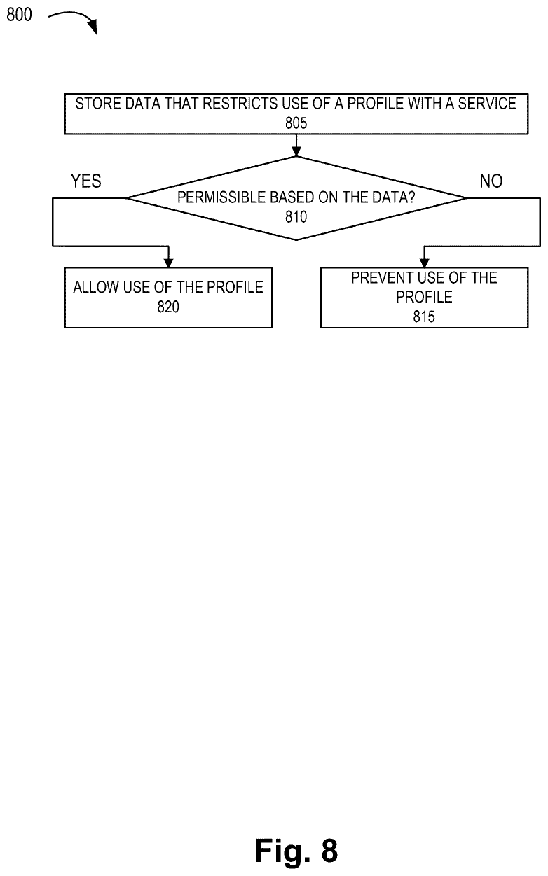

FIG. 8 is a flow diagram illustrating an exemplary process 800 of an exemplary embodiment of the card profile management service. According to an exemplary embodiment, process 800 may be implemented by a card of end device 130, end device 130, or a combination of both the card and end device 130. According to an exemplary implementation, processor 310 may execute software 320 to perform a step of process 800, as described herein. Alternatively, a step may be performed by execution of only hardware. For purposes of description, process 800 is described as being performed by a profile assistant. Additionally, according to an exemplary embodiment of process 800, profiles are associated with service type data and profile assistant may be configured with data that may restrict use of a profile with certain end device applications or services, as described herein. For example, the data may be implemented as type and service data, as described herein.

In block 805, the profile assistant may store (or have access to) a data that restricts use of a profile to one or more end device applications or data services. For example, the data may include a correlation between a service type of a profile and an end device application or data service, as described herein.

In block 810, the profile assistant may determine whether use of the profile with the service is permissible based on the data. For example, the profile assistant may analyze the data relative to the service type of the profile and the end device application or service to determine whether the data permits or prevents the use of the profile.

When the profile assistant determines that the profile cannot be used with the service (block 810—NO), the profile assistant may prevent the use of the profile with the service (block 815). For example, the profile assistant may disable the profile when the end device application or data service is attempting to be used under the profile. When the profile assistant determines that the profile can be used with the service (block 810—YES), the profile assistant may allow the use of the profile with the service (block 820).

FIG. 8 illustrates an exemplary process of the card profile management service, according to other exemplary embodiments, the card profile management service may perform additional operations, fewer operations, and/or different operations than those illustrated and described. As previously described, process 800 may be performed by a component different from the profile assistant, such as an OEM application, the modem of end device 130, a card application other than the profile assistant, or some sub-combination thereof.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIGS. 4-8, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
storing, by a card of an end device, profiles and data instances indicating types of the profiles;
determining, by the card or the end device, whether at least one of an enablement of a first profile of the profiles or a use of the first profile, which has been enabled, with an end device application is permitted based on a first data instance of the data instances that indicates a first type of the first profile;
allowing, by the card or the end device, the at least one of the enablement or the use of the first profile when the first type of the first profile permits the enablement or the use of the first profile; and
preventing, by the card or the end device, the at least one of the enablement or the use of the first profile when the first type of the first profile does not permit the enablement or the use of the first profile.

2. The method of claim 1, wherein the types of the profiles include two or more of consumer, Internet of Things (IoT), or machine to machine (M2M).

3. The method of claim 1, wherein the preventing comprises:
omitting, by the card or the end device, the first profile to be displayed via a user interface configured to receive a selection of one of the profiles for enablement.

4. The method of claim 1, further comprising:
comparing, by the card or the end device, an identifier of the end device application to one or more first identifiers that identify one or more first end device applications that are permitted to be used with the first profile.

5. The method of claim 1, wherein the data instances are profile metadata of the profiles.

6. The method of claim 1, wherein the card or the end device includes a local profile assistant that includes logic that is configured to perform the determining, the allowing, and the preventing.

7. The method of claim 1, further comprising:
detecting, by the card or the end device, a launching of the end device application; and wherein the determining comprises:
determining, by the card or the end device in response to the detecting, whether the use of the first profile with the end device application is permitted based on the first data instance.

8. The method of claim 1, wherein the card is an embedded UICC (eUICC) or a UICC that supports remote provisioning.

9. A device comprising:
a processor, wherein the processor is configured to:
store profiles and data instances indicating types of the profiles;
determine whether at least one of an enablement of a first profile of the profiles or a use of the first profile, which has been enabled, with an end device application is permitted based on a first data instance of the data instances that indicates a first type of the first profile;
allow the at least one of the enablement or the use of the first profile when the first type of the first profile permits the enablement or the use of the first profile; and
prevent the at least one of the enablement or the use of the first profile when the first type of the first profile does not permit the enablement or the use of the first profile.

10. The device of claim 9, wherein the types of the profiles include two or more of consumer, Internet of Things (IoT), or machine to machine (M2M).

11. The device of claim 9, wherein, when preventing, the processor is further configured to:
omit the first profile to be displayed via a user interface configured to receive a selection of one of the profiles for enablement.

12. The device of claim 9, wherein the processor is further configured to:
compare an identifier of the end device application to one or more first identifiers that identify one or more first end device applications that are permitted to be used with the first profile.

13. The device of claim 9, wherein the data instances are profile metadata of the profiles.

14. The device of claim 9, wherein the device includes a local profile assistant.

15. The device of claim 9, wherein the processor is further configured to:
detect a launching of the end device application, and wherein, when determining, the processor is further configured to:
determine, in response to the detection, whether the use of the first profile with the end device application is permitted based on the first data instance.

16. The device of claim 9, wherein the device is an embedded UICC (eUICC) or a UICC that supports remote provisioning.

17. A non-transitory computer-readable storage medium storing instructions
executable by a processor of a device, wherein the instructions are configured to:
store profiles and data instances indicating types of the profiles;
determine whether at least one of an enablement of a first profile of the profiles or a use of the first profile, which has been enabled, with an end device application is permitted based on a first data instance of the data instances that indicates a first type of the first profile;
allow the at least one of the enablement or the use of the first profile when the first type of the first profile permits the enablement or the use of the first profile; and
prevent the at least one of the enablement or the use of the first profile when the first type of the first profile does not permit the enablement or the use of the first profile.

18. The non-transitory computer-readable storage medium of claim 17, wherein the instructions to prevent further instructions configured to:
omit the first profile to be displayed via a user interface configured to receive a selection of one of the profiles for enablement.

19. The non-transitory computer-readable storage medium of claim 17, wherein the instructions are further configured to:
compare an identifier of the end device application to one or more first identifiers that identify one or more first end device applications that are permitted to be used with the first profile.

20. The non-transitory computer-readable storage medium of claim 17, wherein the device is an embedded UICC (eUICC) or a UICC that supports remote provisioning.
